(19) United States
(12) Patent Application Publication
(10) Pub. No.: US 2026/0036748 A1
(43) Pub. Date: Feb. 5, 2026

(54) PASSIVE ALIGNMENT CONNECTION STRUCTURE

(71) Applicant: FOCI FIBER OPTIC COMMUNICATIONS, INC., HSINCHU (TW)

(72) Inventors: Ting-Ta Hu, HSINCHU (TW); Po-Yi Wu, HSINCHU (TW); Chieh-Yu Fang, HSINCHU (TW); Chia-Kuo Chen, HSINCHU (TW); Ting-Yan Lin, HSINCHU (TW)

(21) Appl. No.: 18/888,298

(22) Filed: Sep. 18, 2024

(30) Foreign Application Priority Data
Jul. 31, 2024 (TW) 113128542

(51) Int. Cl. G02B 6/255

(52) U.S. Cl. CPC G02B 6/2555

(57) ABSTRACT

The present invention relates to a passive alignment connection structure. The structure involves a first docking device, having a first frame, a stop frame portion and a first alignment portion, a first accommodation space is defined inside the first frame, the stop frame is disposed in the first frame and divides the first accommodation space inside the first frame into a first accommodation cavity and a second accommodation cavity, the first alignment portion is disposed in a first upper plate portion of the first frame and is disposed adjacent to the first accommodating cavity; and a second docking device, having a second frame and a second alignment portion, the second alignment portion is disposed in a second upper plate portion of the second frame and is disposed corresponding to the first alignment portion, the second alignment portion is combined with the first alignment portion to complete the alignment connection.

### CROSS-REFERENCE TO RELATED APPLICATION

This application claims the priority of Taiwanese patent application No. 113128542, filed on Jul. 31, 2024, which is incorporated herewith by reference.

### BACKGROUND OF THE INVENTION

### 1. Field of the Invention

The present invention relates generally to a technical field of optical fiber connection, and more particularly, to a passive alignment connection structure used to connect optical fiber array modules.

### 2. The Prior Arts

In the current technologies for fiber array connection, the optical fibers inside the two fiber array modules must be aligned with each other for connection to prevent the light beam from discontinuing while traveling. In order to align the optical fibers between the two optical fiber array modules, an external mold must be used to position the two optical fiber array modules during assembly and then be combined through gluing, for example, to complete the alignment connection operation. However, the cost of mold creation is high, and the structure of each model of product is different, resulting in the requirement of different molds for each different model of product, which is very expensive.

### SUMMARY OF THE INVENTION

A primary objective of the present invention is to provide a passive alignment connection structure, which connects two optical fiber array modules respectively through two docking devices each having an alignment portion, and performs alignment through each alignment portion of each docking device. Connections can be made directly during assembly without the need for external molds, thereby improving yield and reducing costs.

In order to achieve the aforementioned objective, the present invention provides a passive alignment connection structure, including: a first docking device having a first frame, a stop frame portion, and a first alignment portion, the first frame defining a first accommodation space, and the stop frame portion being disposed in the first frame and dividing the first accommodation space inside the first frame into a first accommodation cavity and a second accommodation cavity, the first alignment portion being disposed in a first upper plate portion of the first frame and being arranged adjacent to the first accommodating cavity; and a second docking device, having a second frame and a second alignment portion, the second frame defining the second accommodation space and the second accommodation space being provided correspondingly to the first accommodation cavity of the first accommodation space, the second alignment portion is disposed on a second upper plate portion of the second frame, and being provided correspondingly to the first alignment portion, and the second alignment portion being engaged with the first alignment portion to complete the alignment connection.

In some embodiments, the second accommodation cavity of the first docking device is configured for a first optical fiber array module to be inserted and fixed, and abuts against the stop frame portion to be combined and fixed by gluing.

In some embodiments, a first protruding rib is provided in a protruding manner from a bottom of the first optical fiber array module, a first groove is formed on an inner surface of a first lower plate portion of the first frame corresponds to the second accommodation cavity, and the first protruding rib is aligned and positioned corresponding to the first groove.

In some embodiments, the second accommodation space of the second docking device is configured for a second optical fiber array module to be inserted and to be fixed by gluing.

In some embodiments, a front exposed portion of the second optical fiber array module is exposed outside the second docking device and penetrates and fixed in the first accommodation cavity of the first docking device, and abuts against the top of the stop frame.

In some embodiments, a second groove is formed on an inner surface of a second lower plate portion of the second frame, a third groove is formed on an inner surface of the first lower plate portion of the first frame corresponding to the first accommodation cavity, and a second protruding rib protrudes from a bottom of the second optical fiber array module; and the second protruding rib is aligned and positioned corresponding to the second groove and the third groove.

In some embodiments, each of the two sides of the first groove is respectively a first slope, and the first slope is inclined downward toward the center of the first frame; each of the two sides of the third groove are is a third inclined surface respectively, and the third inclined surface is inclined downward toward the center of the first frame.

In some embodiments, each of the two sides of the second groove are respectively a second inclined surface, and the second inclined surface is inclined downward toward the center of the second frame.

In some embodiments, the first alignment portion includes two blind holes spaced apart from each other, the second alignment portion includes two guide posts spaced apart from each other, and the two guide posts are aligned and penetrate into the two blind holes.

In some embodiments, the two guide posts are made of metal.

In order to make the aforementioned objective, features and advantages of the present invention more obvious and easier to understand, the specific embodiments listed in the drawings are described in detail below.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a partially exploded perspective view of the passive alignment connection structure of the present invention.

FIG. 2 is a schematic cross-sectional view of the passive alignment connection structure of the present invention.

FIG. 3 is a partially exploded perspective view of the passive alignment connection structure combined with an optical fiber array module of the present invention.

FIG. 4 is a schematic side view of a passive alignment connection structure combined with an optical fiber array module according to the present invention.

FIG. 5 is a schematic cross-sectional view of the passive alignment connection structure combined with the optical fiber array module of the present invention.

### DETAILED DESCRIPTION OF THE PREFERRED EMBODIMENT

The technical solutions of the present invention will be described clearly and completely below in conjunction with the specific embodiments and the accompanying drawings. It should be noted that when an element is referred to as being “mounted or fixed to” another element, it means that the element can be directly on the other element or an intervening element may also be present. When an element is referred to as being “connected” to another element, it means that the element can be directly connected to the other element or intervening elements may also be present. In the illustrated embodiment, the directions indicated up, down, left, right, front and back, etc. are relative, and are used to explain that the structures and movements of the various components in this case are relative. These representations are appropriate when the components are in the positions shown in the figures. However, if the description of the positions of elements changes, it is believed that these representations will change accordingly.

Unless otherwise defined, all technical and scientific terms used herein have the same meaning as commonly understood by one of ordinary skill in the art of the present invention. The terminology used herein is for the purpose of describing particular embodiments only and is not intended to limit the present invention. As used herein, the term “and/or” includes any and all combinations of one or more of the associated listed items.

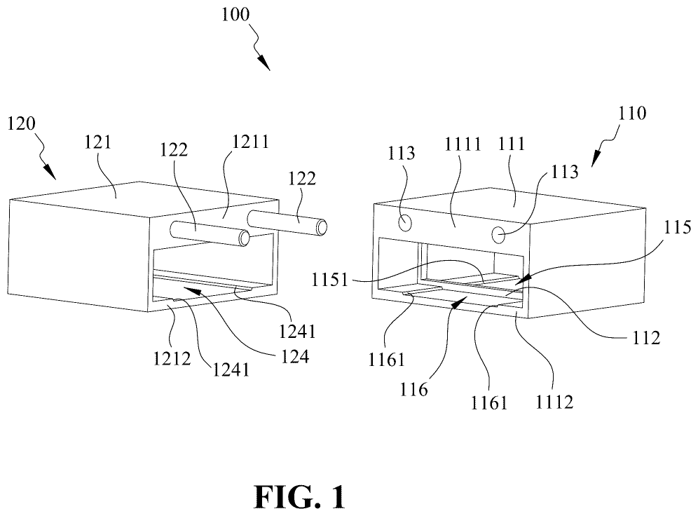

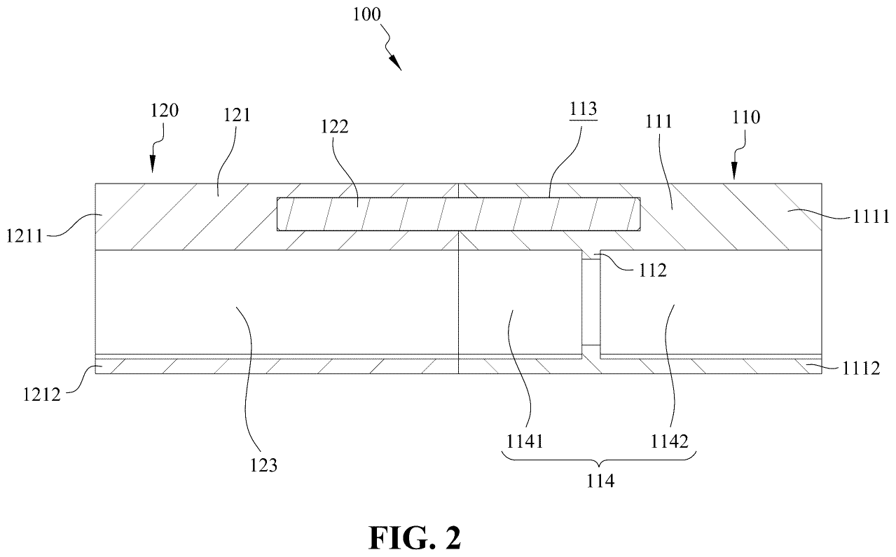

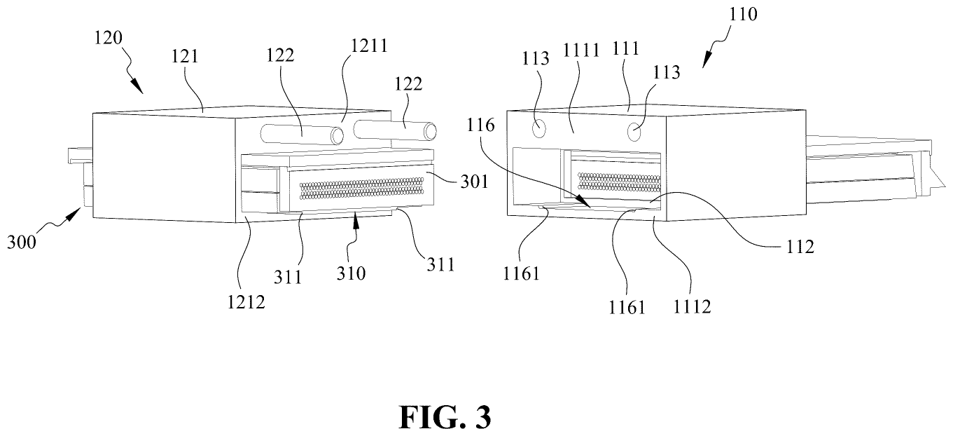

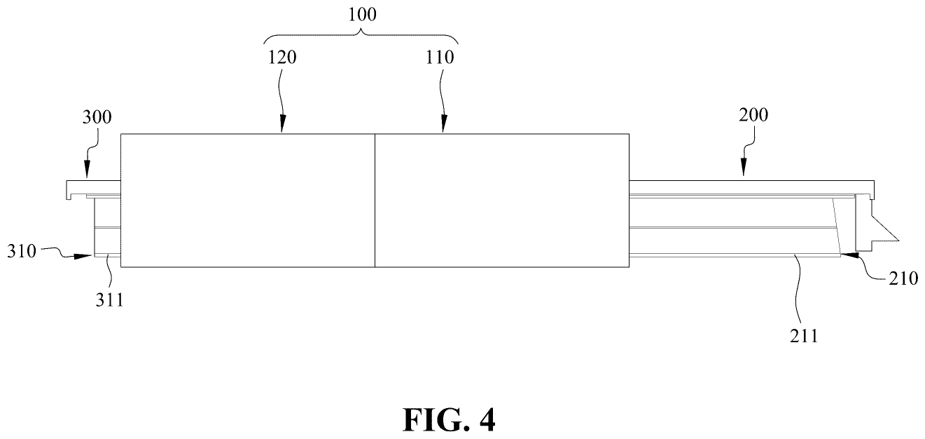

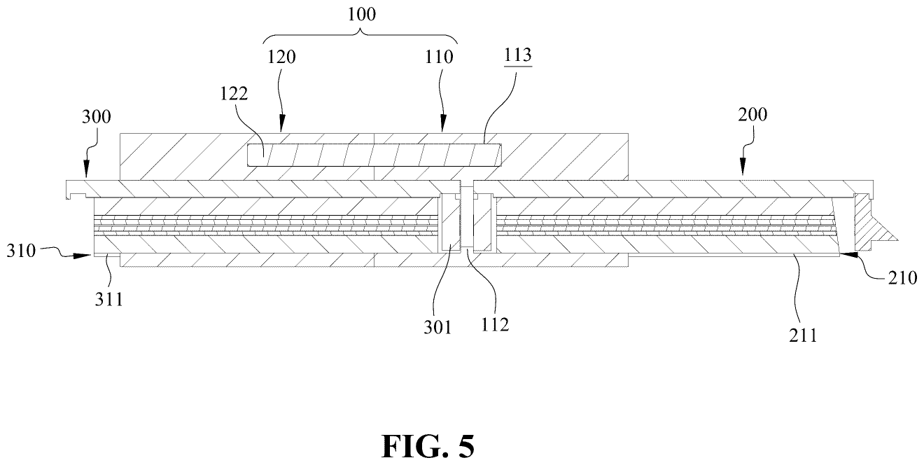

Refer to FIGS. 1-5. FIG. 1 is a partially exploded perspective view of the passive alignment connection structure of the present invention; FIG. 2 is a schematic cross-sectional view of the passive alignment connection structure of the present invention; FIG. 3 is a partially exploded perspective view of the passive alignment connection structure combined with an optical fiber array module of the present invention; FIG. 4 is a schematic side view of a passive alignment connection structure combined with an optical fiber array module according to the present invention; FIG. 5 is a schematic cross-sectional view of the passive alignment connection structure combined with the optical fiber array module of the present invention.

The passive alignment connection structure 100 of the present invention includes a first docking device 110 and a second docking device 120. In some embodiments, the first docking device 110 is configured to connect and fix a first optical fiber array module 200, and the second docking device 120 is configured to connect and fix a second optical fiber array module 300.

The first docking device 110 has a first frame 111, a stop frame portion 112 and a first alignment portion 113. A first accommodation space 114 is defined inside the first frame 111. The stop frame portion 112 is disposed in the first frame 111 and divides the first accommodation space 114 inside the first frame 111 into a first accommodation cavity 1141 and a second accommodation cavity 1142. The first alignment portion 113 is disposed in a first upper plate portion 1111 of the first frame 111 and is located adjacent to the first accommodation cavity 1141.

In some embodiments, the second accommodation cavity 1142 of the first docking device 110 is configured for the first optical fiber array module 200 to be inserted and fixed, abuts against the stop frame 112, and the two can be combined and fixed by gluing. In some embodiments, a first protruding rib 210 is protruding from a bottom of the first optical fiber array module 200. In some embodiments, both sides of the first protruding rib 210 have a fourth slope 211 respectively.

Correspondingly, in some embodiments, a first groove 115 is formed on an inner surface of the first lower plate portion 1112 of the first frame 111 corresponding to the second accommodation cavity 1142, and the first protruding rib 210 is aligned and positioned corresponding to the first groove 115; a third groove 116 is formed on an inner surface of the first lower plate portion 1112 of the first frame 111 corresponding to the first accommodation cavity 1141. In some embodiments, the two sides of the first groove 115 are respectively a first slope 1151, and the two sides of the third groove 116 are respectively a third slope 1161. The first inclined surface 1151 is inclined downward toward the center of the first frame 111, and the third inclined surface 1161 is inclined downward toward the center of the first frame 111. In some embodiments, the central axis of the first groove 115 overlaps the central axis of the third groove 116 so that the first groove 115 and the third groove 116 are aligned with each other. Furthermore, each first inclined surface 1151 of the first groove 115 and each fourth inclined surface 211 of the first protruding rib 210 are aligned with each other.

The second docking device 120 has a second frame 121 and a second alignment portion 122. A second accommodation space 123 is defined inside the second frame 121. The second accommodation space 123 is disposed corresponding to the first accommodating cavity 1141 of the first accommodation space 114 and communicates with it. The second alignment portion 122 is disposed in a second upper plate portion 1211 of the second frame 121 and is disposed corresponding to the first alignment portion 113. The second alignment portion 122 is combined with the first alignment portion 113 to complete the alignment connection. In some embodiments, the first alignment portion 113 may include two blind holes spaced apart from each other, and the second alignment portion 122 may include two guide posts spaced apart from each other, but are not limited thereto. In some embodiments, the second alignment portions 122 that include two guide posts are aligned and penetrate into the first alignment portion 113 that includes two blind holes to achieve aligned and positioned docking. In some embodiments, the two guide posts are made of metal.

In some embodiments, the second accommodation space 123 of the second docking device 120 is configured for the second optical fiber array module 300 to be inserted and fixed by gluing. In some embodiments, a second protruding rib 310 protrudes from a bottom of the second optical fiber array module 300. In some embodiments, a second groove 124 is formed on an inner surface of a second lower plate portion 1212 of the second frame 121. In some embodiments, both sides of the second groove 124 are respectively a second inclined surface 1241, and the second inclined surface 1241 is inclined downward toward the center of the second frame 121. In some embodiments, the second protruding rib 310 is aligned and positioned corresponding to the second groove 124 and the third groove 116. In some embodiments, a fifth slope 311 is formed on both sides of the second protruding rib 310 respectively, and the fifth slope 311 is inclined downward toward the center of the second protruding rib 310.

In some embodiments, a front exposed portion 301 of the second optical fiber array module 300 is exposed outside the second docking device 120 and penetrates and is fixed in the first accommodation cavity 1141 of the first docking device 110, and abuts against the stop frame portion 112.

In summary, the passive alignment connection structure 100 of the present invention can be respectively connected to two optical fiber array modules (i.e., the first optical fiber array module 200 and the second optical fiber array module 300) through the two alignment parts (i.e., the first alignment portion 113 and the second alignment portion 122) of the two docking devices (i.e., the first docking device 110 and the second docking device 120). Moreover, through each alignment portion of each docking device, the alignment and connection can be achieved directly during assembly without the need for external molds, thereby improving yield and reducing costs.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A passive alignment connection structure, comprising:
a first docking device having a first frame, a stop frame portion, and a first alignment portion, the first frame defining a first accommodation space, and the stop frame portion being disposed in the first frame and dividing the first accommodation space inside the first frame into a first accommodation cavity and a second accommodation cavity, the first alignment portion being disposed in a first upper plate portion of the first frame and being arranged adjacent to the first accommodating cavity; and
a second docking device, having a second frame and a second alignment portion, the second frame defining the second accommodation space and the second accommodation space being provided correspondingly to the first accommodation cavity of the first accommodation space, the second alignment portion is disposed on a second upper plate portion of the second frame, and being provided correspondingly to the first alignment portion, and the second alignment portion being engaged with the first alignment portion to complete the alignment connection.

2. The passive alignment connection structure according to claim 1, wherein the second accommodation cavity of the first docking device is configured for a first optical fiber array module to be inserted and fixed, and abuts against the stop frame portion to be combined and fixed by gluing.

3. The passive alignment connection structure according to claim 2, wherein a first protruding rib is provided in a protruding manner from a bottom of the first optical fiber array module, a first groove is formed on an inner surface of a first lower plate portion of the first frame corresponds to the second accommodation cavity, and the first protruding rib is aligned and positioned corresponding to the first groove.

4. The passive alignment connection structure according to claim 3, wherein the second accommodation space of the second docking device is configured for a second optical fiber array module to be inserted and to be fixed by gluing.

5. The passive alignment connection structure according to claim 4, wherein a front exposed portion of the second optical fiber array module is exposed outside the second docking device and penetrates and fixed in the first accommodation cavity of the first docking device, and abuts against the top of the stop frame.

6. The passive alignment connection structure according to claim 5, wherein a second groove is formed on an inner surface of a second lower plate portion of the second frame, a third groove is formed on an inner surface of the first lower plate portion of the first frame corresponding to the first accommodation cavity, and a second protruding rib protrudes from a bottom of the second optical fiber array module; and the second protruding rib is aligned and positioned corresponding to the second groove and the third groove.

7. The passive alignment connection structure according to claim 6, wherein each of the two sides of the first groove is respectively a first slope, and the first slope is inclined downward toward the center of the first frame; each of the two sides of the third groove are is a third inclined surface respectively, and the third inclined surface is inclined downward toward the center of the first frame.

8. The passive alignment connection structure according to claim 7, wherein each of the two sides of the second groove are respectively a second inclined surface, and the second inclined surface is inclined downward toward the center of the second frame.

9. The passive alignment connection structure according to claim 1, wherein the first alignment portion includes two blind holes spaced apart from each other, the second alignment portion includes two guide posts spaced apart from each other, and the two guide posts are aligned and penetrate into the two blind holes.

10. The passive alignment connection structure according to claim 9, wherein the two guide posts are made of metal.
